(19) United States
(12) Patent Application Publication
(10) Pub. No.: US 2005/0228813 A1
(43) Pub. Date: Oct. 13, 2005

(54) Method for communicating and controlling data

(76) Inventors: Alberto Laghi, Ravenna (IT); Giuseppe Rosa, Bologna (IT); Ivano Sangiorgi, Fabbrica d'Imola (BO) (IT)

Correspondence Address: NIXON & VANDERHYE, PC, 901 NORTH GLEBE ROAD, 11TH FLOOR, ARLINGTON, VA, 22203, US

(21) Appl. No.: 10/525,513

(22) PCT Filed: Aug. 7, 2003
(86) PCT No.: PCT/EP03/08774

§ 371 Date: May 19, 2005

(30) Foreign Application Priority Data
Aug. 27, 2002 (IT) BO2002A000545

(51) Int. Cl. G06F 17/00

(52) U.S. Cl. 707/102

(57) ABSTRACT

A method for communicating and controlling data, for example information data concerning intellectual property rights pertaining to a product, provides to arrange and organise a list of data defined by at least an alphanumeric code that identifies the existence of intellectual property rights for protecting a product, and to make available said list by publishing on an Internet site; to the cited product is associated an informative note that exactly refers to the existence of the mentioned intellectual property rights and contains the instructions for addressing to consult said Internet site.

The present invention relates to a method for communicating and controlling data.

In particular, the present invention is advantageously employed for communicating and controlling with updating the information data concerning intellectual property rights pertaining to products.

Here and in the following, with the terms “intellectual property rights”, reference is made in particular, but for this reason without loosing in generality, to the rights of patent and/or of trademark that have been registered for protecting products, and the present invention explicitly refers to the method used for identifying and notifying if, on the products selves, exist patents for industrial invention, or for utility model or for ornamental model and/or trademarks for protecting the products. In particular, the products to which the present invention, with the following description, will explicitly refer, without for this reason loosing in generality, are automatic machines and similar equipments, operating in the field of production and/or packaging of general articles. These machines comprises automatic machines for producing articles used preferably, but not exclusively, in the alimentary, pharmaceutical or cosmetic field, these articles comprising filter-bags for tea or coffee-infusion, pharmaceutical tablets or capsules filled with liquids or powdery material, and/or machines for packaging such articles in containers such as boxes, casings, packets, blisters, bottles, phials and the like.

Generally, when an automatic packaging machine or an operating part thereof is disclosed in and protected by one or more filed patent for industrial invention and/or for utility model, it is actually known to communicate to the public the existence of such industrial property rights by applying in a very visible position, for example on the front portion of the automatic machine, a suitable plaque with a stamped inscription, like “Patented machine”, followed by a list of alphanumeric codes identifying the existing patents.

A code of the mentioned list of codes usually comprises the application or the grant number associated with a two letter international code corresponding to a country in which the patent has been filed or is effective.

Such communicating by publishing the patent information data on plaques with the exact identifying alphanumeric codes not only corresponds with a consolidated known procedure but it is also necessary, according to what is established into the currently effective national and international legislations on industrial property, in order to enable the holder of the patent or patents to exert its own rights against suspected counterfeiter, in case by claiming a refund for the economical and commercial damages suffered during the entire time period during which the counterfeit took place or it is currently taking place.

Thus, it is prevented that the patent holder has to proceed against the suspected counterfeiters by sending notification letters about the existing patent rights, the holder being able, in this last case, to claim for damages only for the counterfeits occurred after said notification.

The data communicating method above-disclosed and currently used, implies however some drawbacks that make, in many cases, said method ineffective, in particular with reference to the exactness of the data published on the plaque.

In effect, when become necessary to update or to adjust the plaque applied on an automatic machine of a particular type or model, or when some of the mentioned alphanumeric codes have to be modified, for example in order to substitute the application number of a particular patent with the respective grant number, and/or to probably add new codes relating, for example, to the so-called “divisional” patent applications that originates from patents that are already mentioned on the plaque but that have been published after the application of the plaque on the machine and that are, in any case, always referred to the same type of machine, and/or in order to correct possible errors present in the codes stamped on the plaque, it will be necessary to substitute the plaques applied in all the sold exemplars of that model of automatic machine.

It is clear that such substituting operation results highly onerous both in terms of time required for carrying out the substitution, and from the economic point of view, particularly in the case of a model of automatic machine that has been sold in several hundreds of exemplars and that works by user customers in all the world.

Furthermore, frequently the zone of the automatic machine whereon the mentioned plaque can be applied has very reduced dimensions, thereby consequently also the plaque has to have very limited dimensions, so that only few data can be visualised on the plaque, the alphanumeric codes of the data are therefore frequently reduced and compressed in size, with the result that the data are hardly read or understood, also by an observer placed at short distance therefrom.

Object of the present invention is to provide a method for communicating and controlling data concerning intellectual property rights for protecting products, by means of which the remarkable drawbacks of the operative known method above-described can be overcome.

In particular, an object of the present invention is to provide a method by means of which information data can be publicly communicated, said information data could be rapidly controlled and updated, thus maintaining the accuracy and the effectiveness of the information reproduced by said data highly reliable.

A further object of the present invention is to provide a method by means of which the communicated data result easy to be read, as well as rapid to be reproduced at any moment, and to be stored on various support means, such as paper supports and computerized medium.

According to the present invention is provided a method for communicating and controlling data, in particular information data concerning intellectual property rights pertaining to a product, the method being characterised in that it comprises the steps of organising a list of data defined by at least an alphanumeric code that identifies the existence of intellectual property rights for protecting a product, and making available said list by publishing on an Internet site; and associating with said product an informative note that refers to the existence of said intellectual property rights and contains the instructions for addressing to consult said Internet site.

The present invention starts from the assumption that exist intellectual property rights for protecting a product, defined specifically but not restrictively by an automatic machine, or portions thereof, operating in the field of production and packaging of articles in general.

Particularly, it is assumed that the mentioned packaging automatic machine, or at least one of its component portions, is protected, by at least one patent application, or by a corresponding granted patent, for industrial invention and/or for utility model, and/or for ornamental model, that patent applications being regularly filed at the appointed Government Industrial Property Office of at least one country of the world, such as one of the member countries of the World Trade Organization (WTO) and/or of the World Intellectual Property Organization. (WIPO), preferably a country adherent to the Patent Cooperation Treaty (PCT).

As already known, a patent application or a corresponding granted patent in a country of the world is identified by means of an alphanumeric code defined in general by a series of numbers and letters and by a two letters code suitable for univocally identifying the country itself.

Such two letters code is internationally recognised and stated by the World Trade Organization, WTO.

For example, the code “U.S. Pat. No. 5,978,562” is suitable for identifying the U.S. patent provided with the license number U.S. Pat. No. 5,978,562 attributed by the United States Patent Office (USPTO), so as the code “IT 3543A/90” is suitable for identifying the Italian patent application provided with the application number 3543A/90, attributed by the Italian Patent and Trademark Office (UIBM).

The present invention further explicitly refers to the actually known tools of the Internet network, i.e. the network at planetary level of information links, that makes available the access, by means of logical connections or links, to a plurality of hypertextual informations of different kind such as texts, images, movies etc., such connections being suitable to be used in the so-called navigation on the World Wide Web (WWW), or for achieving hypertextual connections between Internet sites, defined as sets of organised information in a plurality of hypertextual pages (known as web pages) and provided with respective exact addresses of access, in the following globally indicated with www.x.y.

The communicating data method in subject of the present invention, provides preparing and organising a list of data defined by at least one of the above-mentioned alphanumeric codes that identify a patent application, filed for protecting the mentioned automatic packaging machine, and storing said list in a text file to be made available by publishing said file on a web page of a predefined Internet site, for example as attachment or by direct displaying.

An example of the mentioned list of data/codes is of the type:
U.S. Pat. No. 5,678,901
IT BO2001A0345
EP 1003456 A1
WO 99/20341 A2

Preferably, the list is displayed on the mentioned web page preceded by an explicative comment of the type: “The machine <model or type name> is protected by one or more of the following patent applications/patents:”

The Internet site shows, preferably. on the introducing visual display or homepage of the Internet site, at least an activating button, or a similar element, by activating which (known as click) is enabled direct access to said web page and therefore to the direct display of said data list.

Preferably, the mentioned Internet site is the official reference Internet site of the company that produces and/or deals and/or advertises the automatic machine.

Furthermore, the activating button advantageously displays an inscription or wording referring to the commercial name and/or to the model and/or to the type of the automatic machine, in combination or in alternative with an inscription or wording of the type: “Patents” or equivalent wordings.

The method in subject further includes to provide said automatic machine with an informative note that explicitly refers to the existence of the patent applications/patents, and also to the instructions for accessing to consult said Internet site, whereon the mentioned list has been made public, or to the instructions containing at least the address of said Internet site that, as known, is of the type: http://www.x.y.

Preferably, the mentioned informative note is reproduced or stamped on a plaque suitable for being fixed on at least a visible zone of the external structure of the automatic machine, and carries an inscription or a wording that may be of the type: “For patent information about this machine, please consult the Internet site <www.x.y> at the page <z>”, or, more in detail, of the type: “For information relative to the patent applications/patents filed for protecting this machine, please consult the Internet site <www.x.y> at the page <z>”.

In the case that the mentioned activating button appears on the Internet site, the inscription appearing on the informative note reproduced on the plaque may be of the type: “For information relative to the patent applications/patents filed for protecting this machine, please consult the Internet site <www.x.y> by clicking on the button <k>”.

With the above-described method for communicating data, is, therefore, achieved an optimal, rapid and efficient public distribution of the data relative to the patent protection of a product such as for example a packaging automatic machine, perfectly in concordance with the national and international legislative principles in the subject of industrial property. Actually, the communicating on the Internet network ensures in optimal manner that all the patent informations contained in the mentioned list, and to which reference is made in the mentioned informative note on the plaque applied on the machine, could be rapidly reached, consulted and reproduced in any moment in all the world, in order to verify and control the effective existence of patent rights pertaining to the machine itself.

In particular, anybody having a personal computer can at any moment achieve a connection with the mentioned Internet site and can reproduce in different ways the complete list of alphanumeric codes that identify the patents, for example producing an enlarged printing on paper of the list, or storing the list on computerized supports, such as floppy disk, CD Rom or the like, in order to quietly consult said list subsequently, without having to further connecting on-line with the Internet site.

Furthermore, since the inscriptions defining the mentioned informative note are in any case composed by a very limited number of words, the mentioned plaque can be produced with very reduced dimensions, and, therefore, can be advantageously applied on the automatic machine without encumbrances.

In addition, the same mentioned plaque can be always used and applied also to any other different type or model of automatic machine produced and/or dealt by the same Company, without change both the informative note and the plaque supporting said informative note. The method in subject reaches the prefixed objects since it makes possible rapidly controlling and updating the data, without that this implies heavy and complicated operations for modifying or substituting the plaques, in contrast with what instead happens by applying the method known up to now.

In effect, it is sufficient, for example at fixed intervals of time, to provide to modify or substitute said identifying alphanumeric codes by means of a normal operation of text correcting or text editing of the mentioned list and, subsequently to proceed to immediately re-communicate said web page on said Internet site.

This manner of proceeding is particularly advantageous when have to be added new codes relative for example to the so-called “divisional” patent applications, or in the case of patent applications relative to new improvements suitable for being applied to the same model of machine, or in the case in which are desired to be removed from the list the codes relative to expired or abandoned patents that are, therefore, no more effective.

Thus, very correct and effective information is ensured about the existing and effective rights of industrial property, removing the possibility of errors that can bring to incorrect public information.

It is further highlighted that all the considerations made in the present disclosure with reference to the patent applications/patents can be similarly applied, without substantial changes, to other intellectual property rights, such as trademark applications/registered trademarks relative to products.

In this case, it is possible, for example, to provide that the mentioned informative note reports the name and/or the mark protected by the trademark application/trademark, also with the known symbols © or ®, and that the informative note supports an inscription or wording of the type: “For information about the filed/registered trademarks regarding this product, please consult the Internet site www.x.y” or equivalent inscriptions, while the mentioned list comprises, likewise the patents, the alphanumeric codes that identify the numbers of trademark application or the numbers of registered trademarks in the different countries of the world. The mentioned list can further contain exact references to the product categories for which the trademarks are effective. The mentioned button, eventually, may contain the inscription or wording “Trademarks” or equivalent wordings.

Obviously, the mentioned informative note and all the inscription or wordings mentioned in the present disclosure can be produced and displayed in a single language or in more languages, one of which is preferably the English language, or, in any case, the same language or languages used in the mentioned Internet site.

1-14. (canceled)

15. Method for communicating and controlling data, for example information data concerning intellectual property rights pertaining to a product, the method comprising the steps of organising a list of data defined by at least an alphanumeric code that identifies the existence of intellectual property rights for protecting a product, and making available said list by publishing on an Internet site and associating with said product an informative note that refers to existence of said intellectual property rights and contains instructions for addressing to consult said Internet site.

16. Method according to claim 15, wherein said list is made available by displaying the list on at least one web page of said Internet site, said note further containing instructions for accessing said page of said Internet site.

17. Method according to claim 15, wherein said Internet site displays at least one activating button, or similar element, the activation of which enables said list to be displayed.

18. Method according to claim 17, wherein said activating button displays at least an inscription or wording referring to the commercial name and/or the model and/or the type of said product.

19. Method according to claim 17, wherein said activating button is displayed on the introductive display or on the home page of said Internet site.

20. Method according to claim 15, wherein said Internet site is the official site of the Company that produces and/or deals and/or advertises said product.

21. Method according to claim 15, wherein said alphanumeric code univocally identifies at least one number of patent application or a number of granted patent; said informative note supporting an inscription or wording of the type: “For patent information on this product, please consult the Internet site www.x.y” or equivalent wordings.

22. Method according to claim 16, wherein said alphanumeric code univocally identifies at least one number of patent application or a number of granted patent; said informative note supporting an inscription or wording of the type: “For patent information on this product, please consult the Internet site www.x.y” or equivalent wordings.

23. Method according to claim 22, wherein said informative note supports an inscription or wording of the type: “For information relative to the patent applications/patents filed for protecting the present product, please consult the Internet site <www.x.y> at the page <z>” or equivalent wordings.

24. Method according to claim 17, wherein said informative note supports an inscription of the type “For information relative to the patent applications/patents filed for protecting the present product, please consult the Internet site <www.x.y> by clicking on the button <k>” or equivalent wordings.

25. Method according to claim 17 wherein said activating button displays an inscription or wording of the type “Patents” or equivalent wordings.

26. Method according to claim 21, wherein said list is made available preceded by an explicative comment of the type “The present product is protected by one or more of the following patent applications/patents:” or equivalent wordings.

27. Method according to claim 15, wherein said product comprises an automatic machine, or portions thereof, operating in the field of packaging articles in general, said informative note being reproduced on a plaque suitable for being fixed on at least a visible zone of the external structure of said machine.

28. Method according to claim 15, wherein said alphanumeric code univocally identifies at least a number of trademark application or a number of registered trademark; said informative note carrying an inscription or wording of the type: “For information on the filed/registered trademarks relative to this product, please consult the Internet site www.x.y” or equivalent wordings.

29. Method according to claim 15, and further comprising the step of controlling and updating said list of data at fixed intervals of time by means of an editing operation by means of which said identifying alphanumeric codes of said list are modified or substituted and the step of making immediately available said list by communicating again said list on said Internet site.
